(19) United States
(12) Patent Application Publication
(10) Pub. No.: US 2005/0056708 A1
(43) Pub. Date: Mar. 17, 2005

(54) Apparatus for inducing turbulence in a fluid and method of manufacturing same

(76) Inventor: Jose de Jesus Castillo Higareda, Racine, WI (US)

Correspondence Address: S.C. JOHNSON & SON, INC., 1525 HOWE STREET, RACINE, WI, 53403-2236, US

(21) Appl. No.: 10/864,970

(22) Filed: Jun. 10, 2004

Related U.S. Application Data
(60) Provisional application No. 60/502,439, filed on Sep. 12, 2003.

(51) Int. Cl. B05B 7/32

(52) U.S. Cl. 239/337

(57) ABSTRACT

An apparatus for inducing turbulence in a fluid includes a conduit having a passage therethrough extending between first and second passage ends. First and second offset ribs each extend partially into the passage. The passage tapers throughout a full length of the passage from the first end to the second end.

### CROSS REFERENCE TO RELATED APPLICATIONS

This application claims the benefit of U.S. Provisional Application Ser. No. 60/502,439, filed Sep. 12, 2003.

### REFERENCE REGARDING FEDERALLY SPONSORED RESEARCH OR DEVELOPMENT

Not applicable

### SEQUENTIAL LISTING

Not applicable

### BACKGROUND OF THE INVENTION 1. Field of the Invention

The present invention relates generally to apparatus for inducing turbulence in a fluid, and more particularly to such apparatus having a conduit therethrough.

2. Description of the Background of the Invention

Spraying of product through an apparatus has been known for some time. Often, it is desirable or necessary that the product exiting the apparatus is dispersed in an optimal spray pattern into ambient surroundings in terms of particle size and distribution. Various patents describe spraying apparatus that incorporate turbulence features such as swirl chambers.

Abplanalp et al. U.S. Pat. No. 2,989,251 discloses a spray cap and a circumferential valve stem. The valve stem has an exterior surface and an interior surface defining a central channel. A groove is disposed in the exterior surface. The spray cap is fitted on the valve stem and a spray orifice of the spray cap is aligned with the groove. The product comprising solid particle active ingredients disposed in a pressurized liquid vehicle flows from the central channel, through the groove, and ultimately out of the aligned spray orifice into ambient surroundings. The shape of the groove promotes swirling of the product and uniform distribution of solid constituents of the product.

Green U.S. Pat. No. 3,942,725 discloses a spray head and stem. A socket of the spray head includes a swirl forming chamber and tangential channels in communication therewith. Product exiting the spray head is swirled prior to discharging from the spray head.

Green U.S. Pat. No. 4,036,439 discloses a spray head fitted on a valve stem. The spray head has a cavity into which an insert is disposed. Referring to FIG. 7 thereof, product flows upwardly through the valve stem and then transversely through passages disposed around a central projection and also around wall portions 50 and 51 that span across the flowpath. Flow around the central projection and wall portions 50, 51 causes the product to swirl.

Evesque U.S. Pat. No. 3,433,419 discloses a valve button having a swirl chamber. Abplanalp et al. U.S. Pat. No. 3,008,654 discloses a spray button having a tortuous swirling flowpath and further discloses male and female molding members used to manufacture the spray button.

While there are patents disclosing various turbulence features for mechanical break-up of product flowing therethrough, numerous of these patents disclose a separately manufactured spray insert and/or a large number of tangential channels.

### SUMMARY OF THE INVENTION

In accordance with one aspect of the present invention, an apparatus for inducing turbulence in a fluid includes a conduit having a passage therethrough. The passage extends between first and second passage ends. Each of first and second offset ribs extends partially into the passage. The passage tapers throughout a full length of the passage from the first end to the second end.

According to a further aspect of the present invention, a mold core for forming apparatus that induces turbulence in a fluid includes a tapered region that narrows from a first end to a second end. The tapered region has a longitudinal dimension and a transverse dimension. First and second notches are disposed intermediate the first and second ends. The notches are offset along the longitudinal and transverse dimensions.

In accordance with another aspect of the present invention, a method of manufacturing apparatus for inducing turbulence in a fluid includes the step of providing a mold core having a tapered region tapering from a first end to a second end. The tapered region has a longitudinal dimension and a transverse dimension. First and second notches are disposed intermediate the first and second ends. The notches are offset along the longitudinal and transverse dimensions. A passage is molded from the mold core. The passage extends between first and second passage ends and includes first and second offset ribs each extending partially into the passage. The passage tapers throughout a full length of the passage from the first end to the second end.

Other aspects and advantages of the present invention will become apparent upon consideration of the following detailed description.

### BRIEF DESCRIPTION OF THE DRAWINGS

FIG. 1A is an isometric view illustrating a container and an overcap incorporating the present invention;

FIG. 1B is a fragmentary isometric view showing a spray button adapted to fit on a valve stem;

FIGS. 2 and 3 are fragmentary sectional views illustrating passage portions disposed within the overcap or spray button of FIGS. 1A and 1B;

FIGS. 4A and 4B are enlarged fragmentary elevational views of a mold core according to the present invention used to form a fluid passage in the actuator;

FIG. 4C is a plan view of the mold core of FIGS. 4A and 4B;

FIGS. 5A and 5B are enlarged fragmentary elevational views of the mold core illustrating dimensions of notches of the mold core;

FIGS. 6A and 6B are views similar to FIGS. 4A and 4B further illustrating dimensions of the mold core;

FIG. 6C is a view similar to FIG. 6B but illustrating an opposite side;

FIG. 6D is a view similar to FIG. 6C but illustrating tapering of a cylindrical region of the mold core;

FIGS. 7 and 8 are elevational views of front and rear portions of the overcap of FIG. 1A; and

FIG. 9 is a sectional view of the overcap taken generally along the lines 9-9 of FIG. 8.

### DETAILED DESCRIPTION OF THE PREFERRED EMBODIMENTS

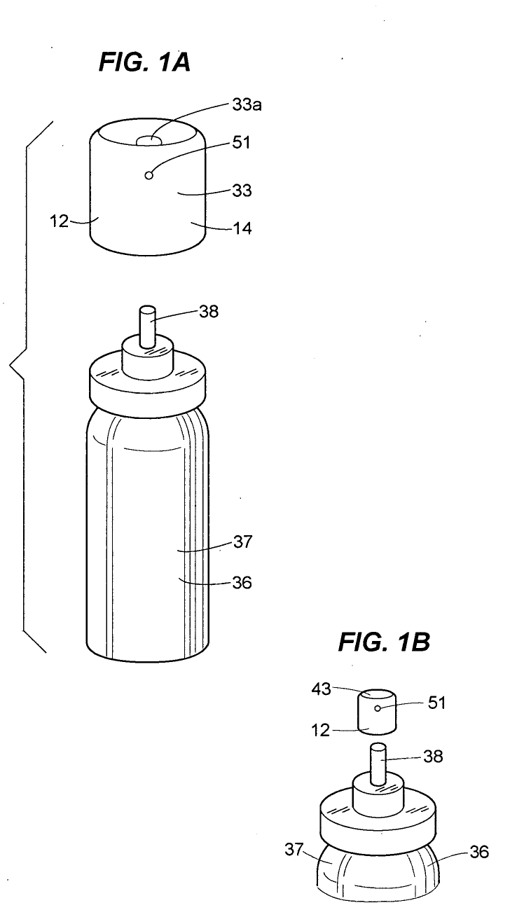

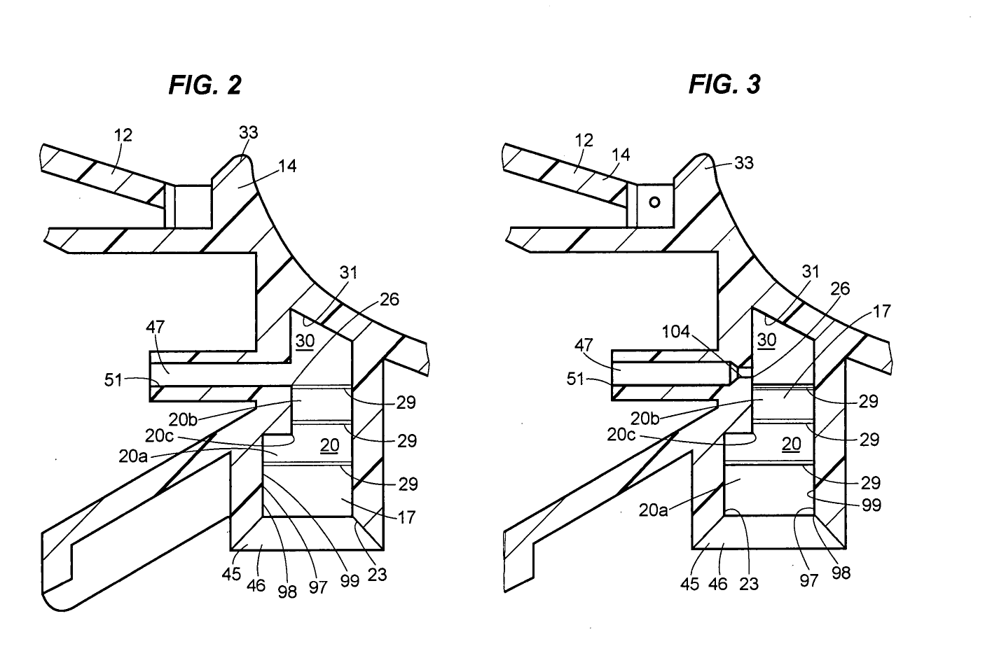

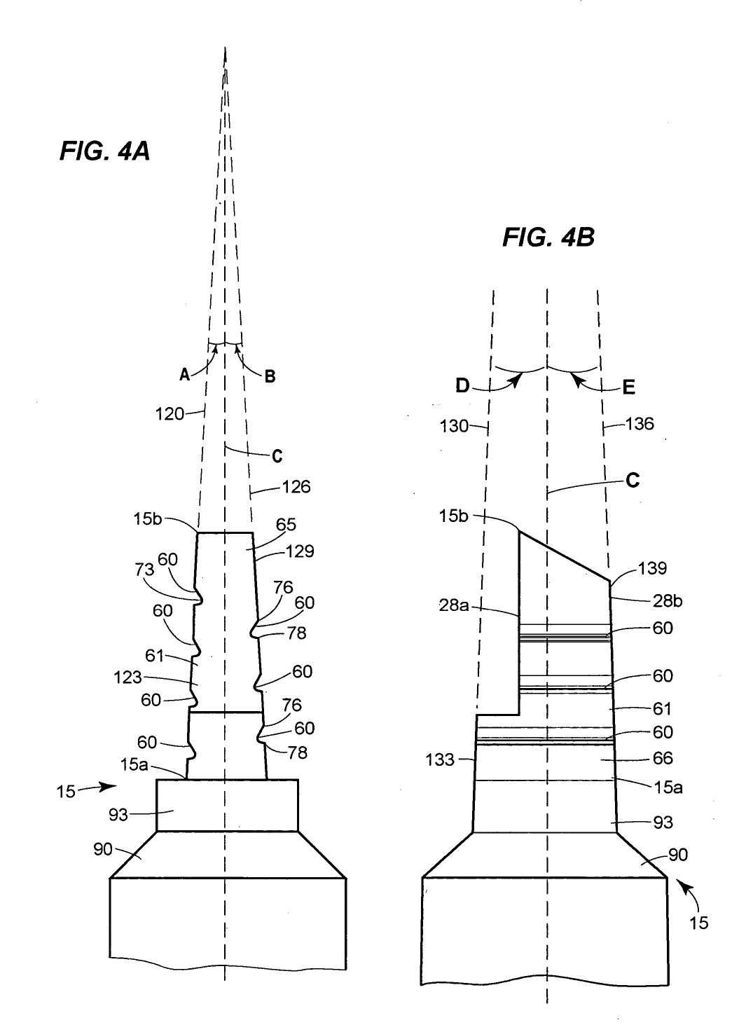

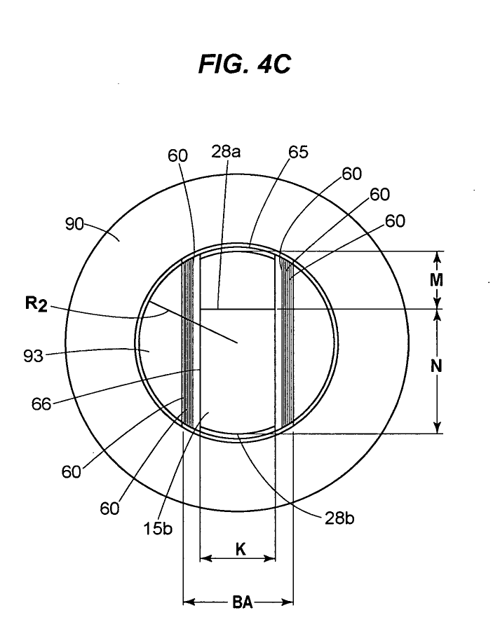

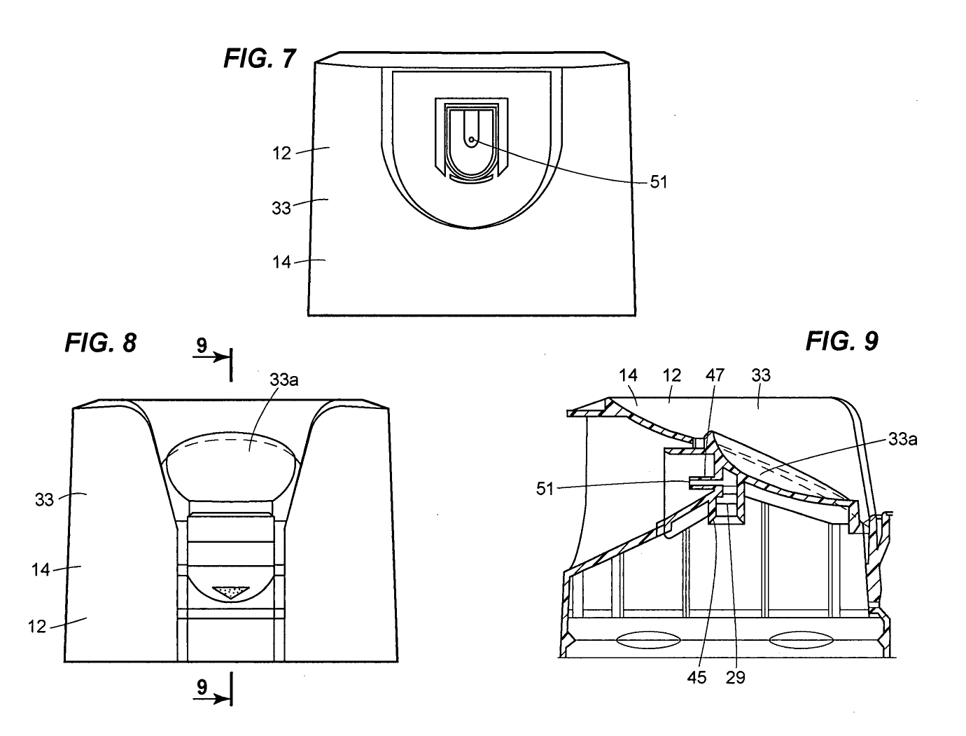

FIGS. 1-3 and 7-9 show an actuator 12 incorporating an apparatus 14 for inducing turbulence in a fluid, while FIGS. 4-6 illustrate a mold core 15 used to form a fluid passage through the apparatus 14. Referring to FIG. 2, a fluid passage 17 includes a first passage portion 20 therethrough that extends between first and second passage ends 23, 26. The passage portion 20 is subdivided into subportions 20a and 20b at a transition area 20c. Although not visible in FIGS. 2 and 3, each passage subportion 20a, 20b tapers throughout a full length thereof. Preferably, although not necessarily, each such taper is substantially uniform over the length of the subportion 20a, 20b, i.e., the tapers are linear. In addition, as noted in greater detail hereinafter, the tapers cause the cross-sectional sizes of the subportions 20a, 20b to decrease in the direction from the first end 23 to the second end 26. The tapering of the passage portion 20 is illustrated more clearly in FIGS. 4A and 4B, which show that the mold core 15 narrows from an end 15a to an end 15b. The mold core 15 may taper in any suitable manner. However, approximate non-limiting exemplary tapering values are provided in Table 1 below for tapering angles A, B, C, D, and E of the mold core 15. One or more surface regions of the mold core 15 could be non-tapered. For example, a surface 28a (FIG. 4B) of the mold core 15 could be non-tapered while a surface 28b opposite thereto is tapered. The narrowing of the passage portion 20 from the end 23 to the end 26 increases flow velocity of product traveling therethrough, which facilitates mixing of the product. A plurality of offset ribs 29 extend partially into the passage portion 20, thereby providing a tortuous and turbulent path for product flowing through the passage portion 20. An additional passage portion or mixing chamber 30 could be provided in communication with the passage portion 20. The mixing chamber 30 may be defined in part by a sloped surface 31, which may improve turbulence in the mixing chamber 30.

The actuator 12 may comprise an overcap 33 (FIG. 1A) for an aerosol container 36 of product. The product could be any of a broad variety of products such as an air freshener, an insect control agent, a paint, a hair spray, a cleaning agent, a polishing agent, a fragrance, or other products stored in a container. A typical product could include a suitable aerosol formulation, which can include any conventional or non-conventional emulsion, suspension, or solution of active ingredients. The product may or may not be maintained under pressure within a body 37 of the container 36 by a suitable propellant. Suitable propellants could include a hydrocarbon propellant or other compressible propellants, as well as non-compressible propellants such as carbon dioxide. Product is ejected from a valve stem 38 by pressing a button 33a of the overcap, thereby either tilting or depressing the valve stem 38 (depending on the design of the valve stem 38) to open a valve (not shown) disposed within the container body 37. Alternatively, as seen in FIG. 1B the actuator 12 may comprise a spray button 43 fitted to the valve stem 38 of the container 36. In any event, the actuator 12 could be made of any suitable material, such as plastic. The actuator 12 may be designed for a container that does not include the valve stem 38 but rather includes a female-type receiver valve (not shown but known in the art). In this case, the actuator 12 would carry a suitable insertion tube that engages the female-type receiver valve to supply the actuator 12 with product.

Referring again to FIGS. 2 and 3, the subportion 20a forms a socket 45 disposed at the first passage end 23, wherein the socket 45 receives the valve stem 38. The socket 45 includes a frustoconical tapered surface 46, which facilitates insertion of the valve stem 38 into the socket 45. The passage portions 20 and 30 extend in a first direction, and a second passage portion 47 extends from the passage portion 20 in a second direction. As shown, the second passage portion 47 is substantially perpendicular to the first passage portion 20. However, the passage portion 47 may be collinear with the passage portion 20 or extend from the passage portion 20 at any angle. In this regard, the angle could vary depending upon the type of product. For some products (e.g., cleaners) it may be desirable to spray in a direction substantially transverse to the valve stem 38, while for other products (e.g., air fresheners) it may be desirable to spray in a direction substantially collinear with the valve stem 38 for spraying product upwardly into the air. The second passage portion 47 terminates in an exit orifice 51 from which product is ultimately dispensed or sprayed into ambient surroundings.

It should be noted that the second passage portion 47 could be omitted and the first passage portion 20 could be provided with a suitable exit orifice (not shown). It should also be noted that the second passage portion 47 could be provided with the ribs 29 instead of, or in addition to the passage portion 20. The second passage portion 47 could also be tapered instead of, or in addition to, the passage portion 20. This would require the use of a mold core similar or identical to the mold core 15 to form the passage portion 47. However, tapering the second passage portion 47 such that the passage portion 47 increases in size toward the exit orifice 51 could be undesirable for some product types (depending upon the desired spray pattern) because this tapering might unduly decelerate the flow velocity, creating particles or droplets larger than desired.

Achieving an optimal spray pattern by providing turbulence in the first passage portion 20 was a surprising and unexpected result because it was uncertain whether the turbulence in the passage portion 20 would maintain the product in an optimal spray pattern as the product flowed through the second passage portion 47 and ultimately out of the exit orifice 51.

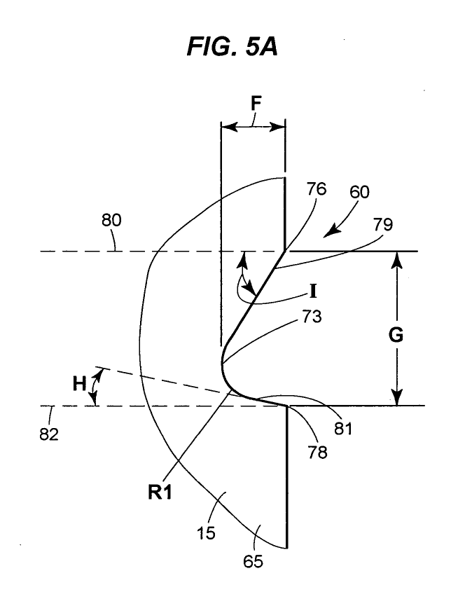

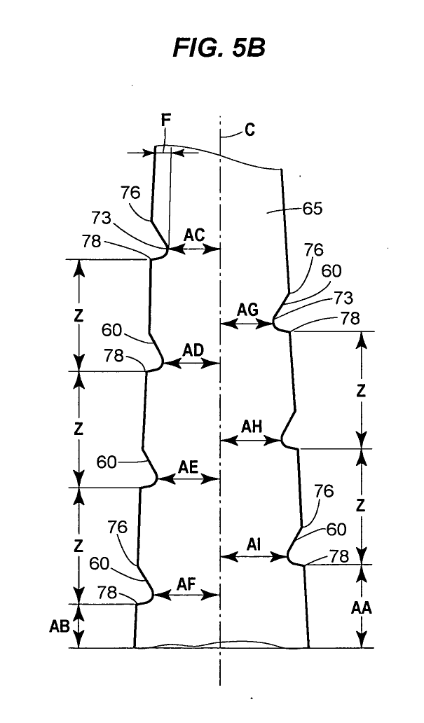

FIGS. 4-6 show a plurality of notches 60 that form the ribs 29. The mold core 15 includes a tapered region 61 that narrows from the end 15a to the end 15b. FIG. 4A shows that the tapered region 61 has a longitudinal dimension L and a transverse dimension T. The notches 60 are disposed intermediate the ends 15a, 15b. The notches 60 are offset along the longitudinal dimension. The notches 60 are also offset along the transverse dimension, and more specifically, the notches 60 are shown disposed on opposite sides of the mold core 15. Accordingly, the ribs 29 are offset in both a longitudinal and a transverse dimension of the passage portion 20. The notches 60 are alternatingly staggered on opposite sides of the core 15 so that the ribs 29 are alternatingly staggered on opposite sides of the passage portion 20. The notches 60 may have any suitable size. For example, as seen in FIG. 5A and Table 1 below, the notches 60 may have a depth dimension F equal to about 0.21 mm and a length dimension G equal to about 0.51 mm. Product flowing through the passage portion 20 flows around the ribs 29 in a zigzag manner. Product flowing around the ribs 29 preferably travels or zigzags from one side of the first passage portion 20 to the other side at least two times and preferably more than two times. Any active ingredient disposed within the product is mixed by the turbulence to optimally provide a substantially homogeneous mixture with droplets or particles having sufficiently consistent size. Optimally, the volume of product leaving the exit orifice 51 is substantially homogenous with a minimum of localized regions of differing particle concentration and/or particle size. Localized concentrated regions may be a disadvantage in terms of waste and inefficient distribution of the product into ambient surroundings, or excessive wetness of the volume sprayed.

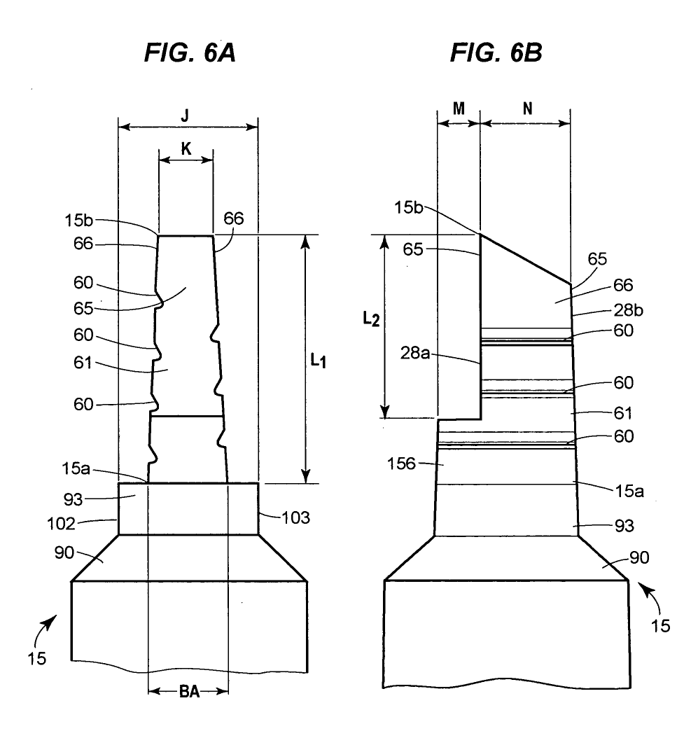

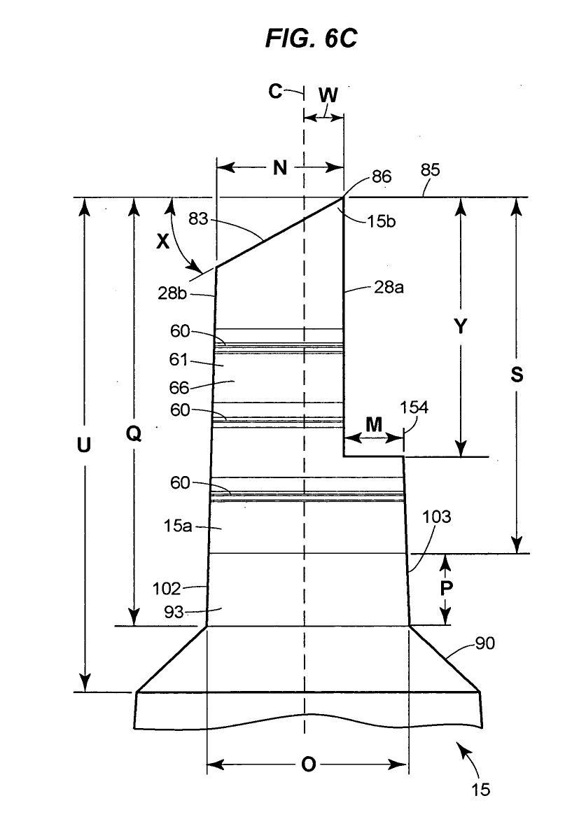

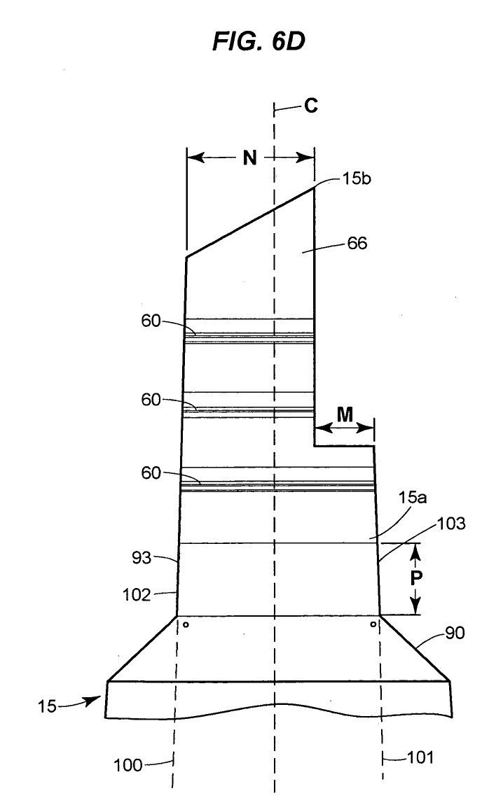

The passage portion 20 may be circular in cross-section or non-circular in cross-section. Preferably, the portion 20 is substantially rectangular in cross-section. Thus, the core 15 has a generally rectangular shape with opposed narrow sidewalls 65 (FIG. 4) and opposed broad sidewalls 66 (FIG. 5). In this regard, it is believed that the rectangular shape of the passage portion 20 allows the passage portion 20 to flex as the core 15 is withdrawn therefrom more so than a square passage so that removal of the core 15 from the fluid passage 17 is facilitated. The tapered profile of the core 15 also facilitates withdrawing same from the fluid passage 17 after the molding process. The tapered profile is especially advantageous considering the core 15 pushes against the ribs 29 as the core 15 is withdrawn from the passage portion 20. As seen in FIGS. 5A and 5B, each of the notches 60 defines a depression 73 with a tapered edge 76 and a sharp edge 78. The tapered edge 76 is disposed on the upper end of each notch 60 (as seen in FIG. 4), which facilitates withdrawal of the core 15 from the fluid passage 17. The depression 73 could include any suitable radius of curvature R, such as 0.1 mm. Each of the edges 76, 78 has a radius of curvature substantially equal to about 0. However, either of the edges 76, 78 could include a radius of curvature greater than 0. Referring particularly to FIG. 5B, the notches 60 may be spaced apart by any suitable distance Z, and preferably, Z is about 1.52 mm. The notches 60 may be spaced any suitable distance from a longitudinal centerline C of the mold core 15, such as the distances or dimensions AC, AD, AE, AF, AG, AH, and AI shown in Table 1 below. Referring again to FIG. 5A, the tapered edge 76 is defined in part by a notch surface 79 that defines an angle I with a horizontal axis 80 passing through the edge 76. The angle I could fall within any suitable range of values, but is preferably about 60.22°. An angle H is defined by a notch surface 81 and a horizontal axis 82 passing through the edge 78. The angle H may be equal to about 13°. Referring to FIG. 6C, the core 15 further includes a sloped surface 83 that forms the sloped surface 31 of the mixing chamber 30. The sloped surface 83 may define an angle X relative to a horizontal axis 85 of about 30°, the axis 85 passing through the longitudinal centerline C at a tip 86 of the core 15. Alternatively, the angle X could be 28.47°. The tapered profile and the tapered edges 76 of the notches 60 allow for withdrawing the mold core 15, which might otherwise be difficult or impossible and thereby avoids the need for inserting a separate turbulence member into the passage portions 20, 47 as an additional assembly step. As generally known in the art, because the second passage portion 47 branches off the first passage portion 20 at an angle, the use of multiple mold cores and withdrawing same in different directions can be quite complicated, which is a reason why turbulence inserts have been frequently used in lieu of complicated mold parts in prior art devices. While the present invention avoids the need for a turbulence insert, one could optionally provide an insert in one of the passage portions 20, 30, 47.

Referring to FIG. 6D, the core 15 includes a tapered region 90 that forms the frustoconical tapered surface 46 and a cylindrical region 93 of circular cross-section that forms a cylindrical sealing region 97 (FIGS. 2, 3) spanning between points 98, 99 of the passage 17. The sealing region 97 is circular so that the sealing region 97 seals the circular valve stem 38 in an effective fluid-tight manner, while the passage portion 20 is substantially rectangular to best facilitate withdrawal of the core 15. The cylindrical region 93 may be tapered. For example, FIG. 6D shows lines 100, 101 collinearly extending from diametrically opposite surfaces 102, 103, respectively, of the region 93. As shown, the lines 100, 101 taper relative to the longitudinal centerline C. Each of the lines 100, 101 may define a tapering angle of about 3 ° relative to the centerline C.

As seen in FIG. 3, a third passage portion 104 may be provided between the passage portion 20 and the passage portion 47. The third passage portion 104 is shown having a smaller or constricted cross-sectional size relative to the passage portions 20, 47. This constriction increases the flow velocity in the third passage portion 104 and also increases the pressure of product within the passage portions 20, 30. The third passage portion 104 could alternatively have a cross-sectional size larger than the passage portions 20, 47 where a decrease in flow velocity is desired for a given product. As should be evident, the size of the third passage portion 104 may be varied to increase the flow velocity as desired for a given product. In addition, the degree of tapering or narrowing of the passage portion 20 might be varied depending upon the product type and the desired flow velocity therefor.

A major advantage of the actuator 12 is that manufacturing the passage portion 20 with the mold core 15 allows the passage portion 20 to be formed in a single unit operation without the need for other complicated mold parts. The mold core 15 is relatively simple in construction.

Table 1 below includes sample dimensions for one example according to the present invention. The following dimensions are not to be construed as limiting and are merely exemplary. (All dimensions are in millimeters unless otherwise specified.)

TABLE 1

| Reference | Dimension |
|---|---|
| A | 2.79° |
| B | 2.78° |
| D | 1.5° |
| E | 1.14° |
| F | 0.21 |
| G | 0.51 |
| H | 12.88° |
| I | 60.22° |
| J | 3.91 |
| K | 1.5 |
| L₁ | 7.19 |
| L₂ | 5.25 |
| M | 1.2 |
| N | 2.54 |
| O | 4.07 |
| P | 1.5 |
| Q | 8.7 |
| R₁ | 0.1 |
| R₂ | 1.96 |
| S | 7.2 |
| U | 10 |
| W | 0.7 |
| X | 30° |
| Y | 5.25 |
| Z | 1.52 |
| AA | 1.07 |
| AB | 0.56 |
| AC | 0.66 |
| AD | 0.73 |
| AE | 0.81 |
| AF | 0.88 |
| AG | 0.71 |
| AH | 0.78 |
| AI | 0.85 |
| BA | 2.21 |

Referring to FIGS. 4A and 4B, a dimension line 120 collinearly extending from a surface 123 of the mold core 15 defines a tapering angle A of about 2.79° relative to the centerline C. A line 126 collinearly extending from a surface 129, opposite the surface 123, defines an angle B of about 2.780 relative to the centerline C. A line 130 collinearly extending from a surface 133 defines an angle D of about 1.5°. A line 136 collinearly extending from a surface 139 defines an angle E of about 1.14°. Referring to FIG. 4C, a radius R₂ is equal to about 1.96 mm, which is equal to one half of the dimension J. Dimension BA (FIGS. 4C and 6A), defined between dimension lines 170 is equal to about 2.21 mm. Alternatively, the dimension BA could be equal to about 2.24 mm.

### Industrial Applicability

In operation, a user depresses the actuator 12, which depresses and/or tilts the valve stem 38 seated within the socket 45, thereby opening a valve (not shown) disposed within the container body 20 and allowing product to flow through the valve stem 38. Product flows around the alternatingly staggered ribs 29 in a zigzag manner through the passage portion 20, the mixing chamber 30, the optional passage portion 104 (if present), the second passage portion 47, and out the exit orifice 51. As the product flows around the ribs 29, the product is mixed as described above on account of the turbulence provided thereby.

A method of manufacturing the apparatus 14 includes the steps of providing the mold core 15, molding the passage 17 with the mold core 15, and removing the mold core 15 from the passage 17. The tapered profile of the mold core 15 as well as the rounded edges 76 of the notches 60 facilitate withdrawal of the mold core 15 from the passage portion 20.

As discussed above, the actuator 12 may be used with a container that includes a female receiver-type valve arrangement rather than the valve stem 38. As also discussed above, the passage portion 47 could be provided with one or more features of the passage portion 20 instead of or in addition thereto. It should be noted that while the foregoing embodiments are described in connection with an aerosol container of pressurized product, the actuator 12 might also be of a pump type where depressing the actuator 12 pumps air into the container body 20, thereby pressurizing the product therein and forcing the product to flow out of the container body 20 and through the actuator 12.

Numerous modifications to the present invention will be apparent to those skilled in the art in view of the foregoing description. Accordingly, this description is to be construed as merely exemplary of the inventive concepts taught herein and is presented for the purpose of enabling those skilled in the art to make and use the invention and to teach the best mode of carrying out same. The exclusive rights to all modifications which come within the scope of the appended claims are reserved.

1. Apparatus for inducing turbulence in a fluid, comprising:
a conduit having a passage therethrough extending between first and second passage ends; and
first and second offset ribs each extending partially into the passage;
wherein the passage tapers throughout a full length of the passage from the first end to the second end.

2. The apparatus of claim 1, incorporated into an actuator for an aerosol container.

3. The apparatus of claim 2, wherein the actuator comprises an overcap fitted to a container of product.

4. The apparatus of claim 2, wherein the actuator comprises a spray button fitted to a valve stem of a container of product.

5. The apparatus of claim 1, wherein the first passage end has a first cross-sectional size and the second passage end has a second cross-sectional size different than the first cross-sectional size.

6. The apparatus of claim 5, wherein the first passage end is a fluid inlet end and the second passage end is a fluid outlet end.

7. The apparatus of claim 5, wherein the first passage end is a fluid outlet end and the second passage end is a fluid inlet end.

8. The apparatus of claim 5, wherein the first cross-sectional size is larger than the second cross-sectional size.

9. The apparatus of claim 1, wherein the ribs are offset along a longitudinal dimension of the passage.

10. The apparatus of claim 9, wherein the ribs are offset along a dimension transverse to the longitudinal dimension.

11. The apparatus of claim 10, wherein product flows through the passage around the ribs in a zigzag manner.

12. The apparatus of claim 2, wherein the actuator includes a socket that receives a valve stem extending from a container and wherein actuation of the valve stem supplies the passage with product.

13. The apparatus of claim 12, wherein the socket is disposed at the first passage end.

14. The apparatus of claim 2, wherein the passage comprises a first passage portion extending in a first direction and the apparatus further comprises a second passage portion extending from the first passage portion in a second direction.

15. The apparatus of claim 14, wherein the second direction is transverse to the first direction.

16. The apparatus of claim 15, wherein the second direction is substantially perpendicular to the first direction.

17. The apparatus of claim 14, wherein the second passage portion terminates at an exit orifice.

18. The apparatus of claim 14, further comprising a third passage portion intermediate the first and second passage portions.

19. The apparatus of claim 18, wherein the third passage portion is narrower in cross-sectional size than the first and second passage portions.

20. The apparatus of claim 1, wherein at least a part of the passage is non-circular in cross-section.

21. The apparatus of claim 20, wherein the at least one passage part is substantially rectangular in cross-section.

22. A mold core for forming apparatus that induces turbulence in a fluid, comprising:
a tapered region that narrows from a first end to a second end wherein the tapered region has a longitudinal dimension and a transverse dimension; and
first and second notches intermediate the first and second ends wherein the notches are offset along the longitudinal and transverse dimensions.

23. The mold core of claim 22, wherein the apparatus is incorporated into an actuator for an aerosol container.

24. The mold core of claim 22, wherein at least a part of the tapered region is non-circular in cross-section.

25. The mold core of claim 24, wherein the at least one part is substantially rectangular in cross-section.

26. The mold core of claim 22, wherein each of the notches defines first and second edges and a central depression therebetween and wherein the first edge is rounded.

27. A method of manufacturing apparatus for inducing turbulence in a fluid, the method comprising the steps of:
providing a mold core having a tapered region tapering from a first end to a second end wherein the tapered region has a longitudinal dimension and a transverse dimension and first and second notches intermediate the first and second ends wherein the notches are offset along the longitudinal and transverse dimensions; and
molding a passage from the mold core wherein the passage extends between first and second passage ends and includes first and second offset ribs each extending partially into the passage wherein the passage tapers throughout a full length of the passage from the first end to the second end.

28. The mold core of claim 27, wherein at least a part of the tapered region is non-circular in cross-section.

29. The mold core of claim 28, wherein the at least one part is substantially rectangular in cross-section.

30. The mold core of claim 27, wherein each of the notches defines first and second edges and a central depression therebetween and wherein the first edge is rounded.
